(19) United States
(12) Patent Application Publication
(10) Pub. No.: US 2025/0077818 A1
(43) Pub. Date: Mar. 6, 2025

(54) METHOD FOR TRAINING PATTERN ENHANCING MODEL AND ELECTRONIC DEVICE

(71) Applicant: PEGATRON CORPORATION, TAIPEI CITY (TW)

(72) Inventors: Chen-An Lin, Taipei City (TW); Chao-Chien Lee, Taipei City (TW); Jen-Hui Wang, Taipei City (TW); Chun-Hsi Wu, Taipei City (TW)

(73) Assignee: PEGATRON CORPORATION, TAIPEI CITY (TW)

(21) Appl. No.: 18/795,080

(22) Filed: Aug. 5, 2024

(30) Foreign Application Priority Data
Aug. 28, 2023 (TW) 112132327

(51) Int. Cl. G06K 7/14; G06V 10/98

(52) U.S. Cl. CPC G06K 7/1473; G06K 7/1417; G06V 10/98

(57) ABSTRACT

The embodiment of the disclosure provides a method for training a pattern enhancing model and an electronic device. The method includes: reading a first pattern with a defect via a pattern reader, and determining whether the pattern reader reads successfully; if a reading is successful, performing a pattern reconstruction operation based on pattern information of the read first pattern to obtain a second pattern; training the pattern enhancing model based on the first pattern and the second pattern as a training data set.

### CROSS-REFERENCE TO RELATED APPLICATION

This application claims the priority benefit of Taiwan application serial no. 112132327, filed on Aug. 28, 2023. The entirety of the above-mentioned patent application is hereby incorporated by reference herein and made a part of this specification.

### BACKGROUND

### Technical Field

The disclosure relates to a model training mechanism, and particularly relates to a method for training a pattern enhancing model and an electronic device.

### Description of Related Art

In the prior art, when a pattern reading device is used to read a pattern such as a barcode, if the pattern itself has defects (such as dirt, blur, etc.), one can only rely on the error tolerance of the pattern reading device during recognition to try to read the information carried by the pattern.

Generally speaking, when the proportion of defects in the pattern is less than 30%, the pattern reading device can still read the information carried by the pattern. However, when the defects in the pattern are too serious (for example, greater than 30%), the pattern reading device will be unable to successfully read the information carried by the pattern.

### SUMMARY

In view of this, the disclosure provides a method for training a pattern enhancing model and an electronic device, which can be used to solve the above technical problems.

An embodiment of the disclosure provides a method for training a pattern enhancing model, which is adapted for an electronic device, including: reading a first pattern with a defect via a pattern reader, and determining whether the pattern reader reads successfully; if a reading is successful, performing a pattern reconstruction operation based on pattern information of the read first pattern to obtain a second pattern; and training the pattern enhancing model based on the first pattern and the second pattern as a training data set.

An embodiment of the disclosure provides an electronic device including a storage circuit and a processor. The storage circuit stores a program code. The processor is coupled to the storage circuit and accesses the program code to execute: reading a first pattern with a defect via a pattern reader, and determining whether the pattern reader reads successfully; if a reading is successful, performing a pattern reconstruction operation based on pattern information of the read first pattern to obtain a second pattern; and training the pattern enhancing model based on the first pattern and the second pattern as a training data set.

### BRIEF DESCRIPTION OF THE DRAWINGS

FIG. 1 is a schematic diagram of an electronic device according to an embodiment of the disclosure.

FIG. 2 is a flowchart of a method for training a pattern enhancing model according to an embodiment of the disclosure.

FIG. 3 is a schematic diagram of training a pattern enhancing model according to an embodiment of the disclosure.

FIG. 4 is a schematic diagram of enhancing a pattern enhancing model according to an embodiment of the disclosure.

### DESCRIPTION OF THE EMBODIMENTS

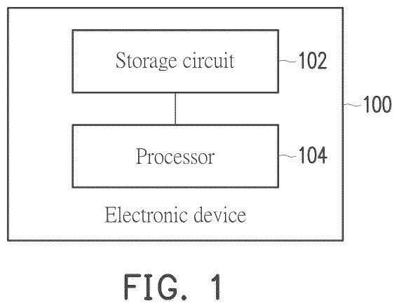

Referring to FIG. 1, which is a schematic diagram of an electronic device according to an embodiment of the disclosure. In different embodiments, an electronic device 100 may be implemented as various smart devices and/or computer devices, but the disclosure is not limited thereto. In an embodiment, the electronic device 100 may also be disposed with a pattern reader (e.g., a barcode reader). In other embodiments, the pattern reader can also be externally connected to the electronic device 100, but the disclosure is not limited thereto.

In FIG. 1, the electronic device 100 includes a storage circuit 102 and a processor 104.

The storage circuit 102 is, for example, any form of fixed or movable random access memory (RAM), a read-only memory (ROM), a flash memory, a hardware disc, or other similar devices, or a combination thereof, which may be used to record a plurality of program codes or modules.

The processor 104 is coupled to the storage circuit 102 and can be a general purpose processor, a special purpose processor, a conventional processor, a digital signal processor, a plurality of microprocessors, one or a plurality of microprocessors combined with a digital signal processor core, a controller, a microcontroller, an application specific integrated circuit (ASIC), a field programmable gate array (FPGA), any other type of integrated circuit, state machine, advanced RISC machine (ARM) based processor, and the like.

In the embodiment of the disclosure, the processor 104 can access the modules and program codes stored in the storage circuit 102 to implement the method for training the pattern enhancing model proposed in the disclosure, the details of which are described in detail below.

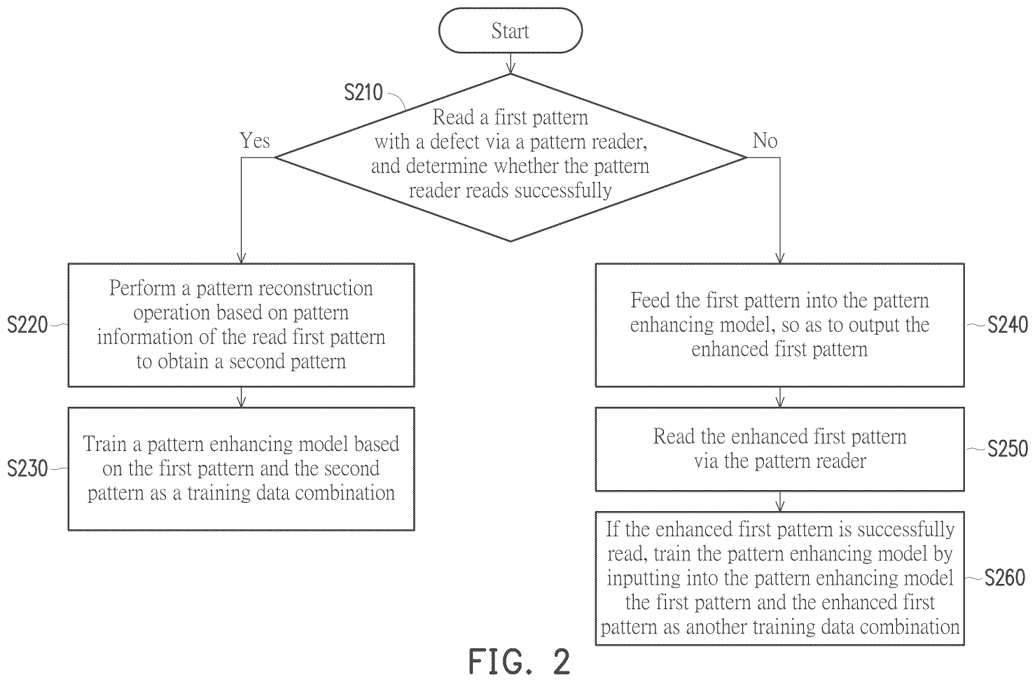

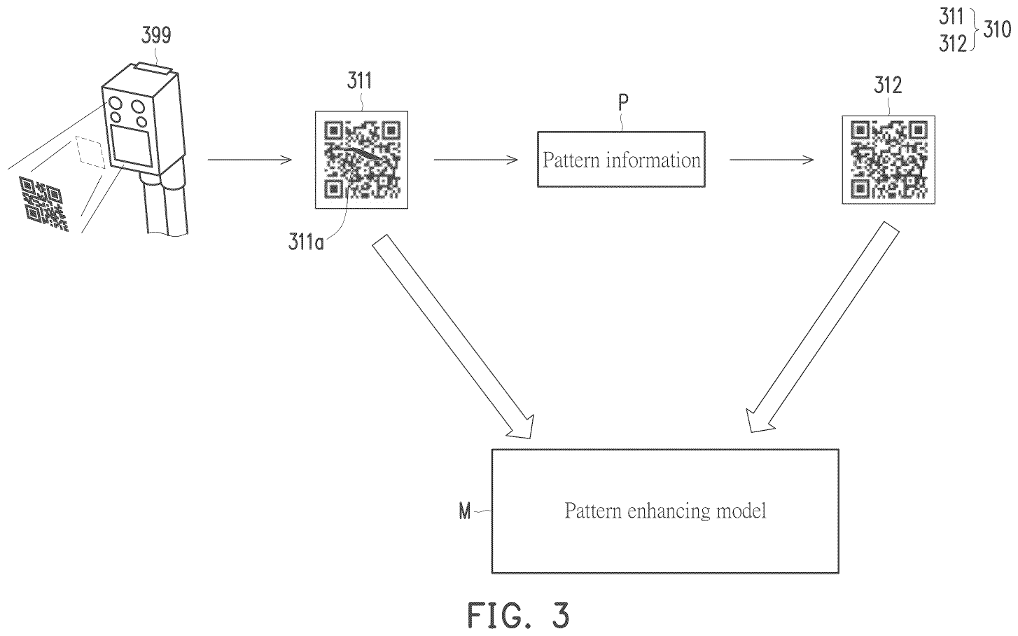

Referring to FIG. 2, which is a flowchart of a method for training a pattern enhancing model according to an embodiment of the disclosure. The method of the embodiment can be executed by the electronic device 100 in FIG. 1. The details of each step in FIG. 2 will be described below with reference to the components shown in FIG. 1. In addition, in order to make the concept of the disclosure easier to understand, the following will be supplemented by the scenario of FIG. 3 for explanation, in which FIG. 3 is a schematic diagram of training a pattern enhancing model according to an embodiment of the disclosure.

In step S210, the processor 104 reads a first pattern 311 with a defect 311a (such as dirt or wear) via a pattern reader 399, and determines whether the pattern reader 399 reads successfully.

In different embodiments, the first pattern 311 is, for example, a barcode, a QR code, or other identifiable patterns that can carry specific information, but the disclosure is not limited thereto.

In the scenario of FIG. 3, the processor 104 can determine whether the pattern reader 399 has successfully read the first pattern 311 after the pattern reader 399 reads the first pattern 311. For example, the processor 104 can determine whether the pattern reader 399 successfully reads pattern information P carried by the first pattern 311.

In an embodiment, the proportion of the defect 311a in the first pattern 311 may be less than a threshold. In different embodiments, the threshold is, for example, an upper limit value at which the pattern reader 399 can still successfully read the pattern information P carried by the first pattern 311.

For example, assuming that the pattern reader 399 can successfully read the pattern information carried by the pattern when the obtained pattern includes a defect with an area less than 30% of the pattern, the above threshold can be 30%, but the disclosure is not limited thereto. In other words, when the threshold is 30%, even if there are defects such as dirt in the obtained pattern, as long as the area of the defect does not exceed 30% of the pattern, the pattern reader 399 can still successfully read the pattern information carried by the pattern, but the disclosure is not limited thereto.

Based on this, after the pattern reader 399 successfully reads the first pattern 311, the pattern reader 399 can obtain the pattern information P carried by the first pattern 311 (such as information about a certain product, a certain website, etc.).

In step S220, the processor 104 may perform a pattern reconstruction operation based on the pattern information P of the read first pattern 311 to obtain a second pattern 312. In the scenario of FIG. 3, since the first pattern 311 is, for example, a QR code, when the processor 104 performs the pattern reconstruction operation, the processor 104 can, for example, feed the obtained pattern information P into the application and/or webpage originally configured to generate the first pattern 311, so as to allow the application and/or webpage to generate the complete first pattern 311 (i.e., the first pattern 311 without the defect 311a) based on the pattern information P. Afterwards, the processor 104 may, for example, use the complete first pattern 311 (i.e., the first pattern 311 without the defect 311a) as the second pattern 312, but the disclosure is not limited thereto.

In step S230, the processor 104 trains a pattern enhancing model M based on the first pattern 311 and the second pattern 312 as a training data set 310, so as to allow the pattern enhancing model M to learn accordingly.

In different embodiments, the pattern enhancing model M can be implemented as various models based on convolutional neural networks (CNN), such as autoencoders, CycleGANs, etc., but the disclosure is not limited thereto.

After the pattern enhancing model M undergoes the above training, the corresponding relationship between the first pattern 311 with the defect 311a and the complete first pattern 311 (for example, the second pattern 312) can be learned.

After completing the training of the pattern enhancing model M, the pattern enhancing model M can accordingly enhance a pattern to be identified when receiving the pattern to be identified including a defect. In this case, the pattern to be identified including the defect can be enhanced (or restored) to a form without a defect or with a smaller amount of defects, so as to increase the possibility that the pattern to be identified will be correctly identified later.

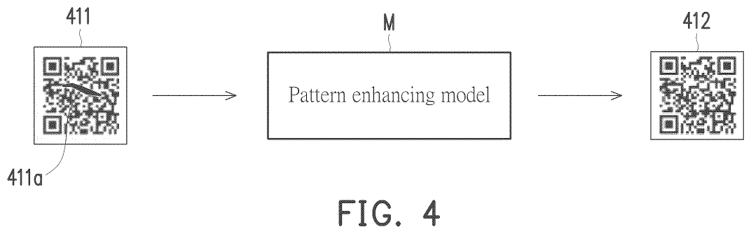

Referring to FIG. 4, which is a schematic diagram of enhancing a pattern enhancing model according to an embodiment of the disclosure.

In FIG. 4, it is assumed that the processor 104 reads a first pattern 411 including a defect 411a via the pattern reader 399. In this case, the processor 104 may determine whether the pattern reader 399 reads successfully (step S210). For example, the processor 104 can determine whether the pattern reader 399 successfully obtains the pattern information carried by the first pattern 411.

If so, this means that the defect 411a does not affect the processor 104's ability to read the pattern information carried by the first pattern 411. In this case, the processor 104 may perform steps S220 and S230 accordingly, and reference may be made to the previous description for the details thereof, and so are not repeated here.

On the other hand, if the processor 104 determines that the pattern reader 399 has failed to read (for example, the pattern information carried by the first pattern 411 cannot be read), it means that the severity of the defect 411a has prevented the processor 104 from successfully reading the pattern information carried by the first pattern 411. In this case, the processor 104 may accordingly perform step S240 to feed the first pattern 411 into the pattern enhancing model M, so that the pattern enhancing model M outputs the enhanced first pattern 411.

In the embodiment, the enhanced first pattern 411 is, for example, a third pattern 412, that is, the first pattern 411 without the defect or with a smaller amount of defects, but the disclosure is not limited thereto.

In step S250, the processor 104 may read the enhanced first pattern 411 (e.g., the third pattern 412) via the pattern reader 399. Since the defects in the third pattern 412 have been greatly reduced compared to the first pattern 411, the pattern reader 399 should be able to read the pattern information carried by the third pattern 412 more smoothly, but the disclosure is not limited thereto.

In step S260, if the pattern reader 399 successfully reads the enhanced first pattern 411 (e.g., the third pattern 412), the processor 104 trains the pattern enhancing model M by inputting into the pattern enhancing model M the first pattern 411 and the enhanced first pattern 411 (e.g., the third pattern 412) as another training data set. Accordingly, the pattern enhancing model M can learn the corresponding relationship between the first pattern 411 with the defect 411a and the enhanced first pattern 411 (for example, the third pattern 412).

In summary, the method proposed in the disclosure can use defective and non-defective versions of the pattern as the training data set to train the pattern enhancing model, so as to allow the pattern enhancing model to learn the corresponding relationship between the above two versions. Later, when the trained pattern enhancing model receives a pattern to be identified including a defect, the pattern to be identified including a defect can be enhanced accordingly to generate a pattern without a defect (or with a smaller amount of defects), so as to help the pattern reader read the pattern information carried by the pattern to be identified.

Although the disclosure has been described with reference to the embodiments above, the embodiments are not intended to limit the disclosure. Any person skilled in the art can make some changes and modifications without departing from the spirit and scope of the disclosure. Therefore, the scope of the disclosure will be defined in the appended claims.

What is claimed is:

1. A method for training a pattern enhancing model, adapted for an electronic device, comprising:
reading a first pattern with a defect via a pattern reader, and determining whether the pattern reader reads successfully;
if a reading is successful, performing a pattern reconstruction operation based on pattern information of the read first pattern to obtain a second pattern; and
training the pattern enhancing model based on the first pattern and the second pattern as a training data set.

2. The method according to claim 1, wherein if the reading is successful, a proportion of the defect of the first pattern in the first pattern is less than a threshold.

3. The method according to claim 1, wherein the first pattern comprises a barcode or a QR code.

4. The method according to claim 1, further comprising:
if the reading fails, feeding the first pattern into the pattern enhancing model to output an enhanced first pattern; and
reading the enhanced first pattern via the pattern reader.

5. The method according to claim 4, further comprising:
if the enhanced first pattern is successfully read, training the pattern enhancing model based on the first pattern and the enhanced first pattern as another training data set.

6. The method according to claim 1, wherein the pattern enhancing model comprises an autoencoder.

7. An electronic device, comprising:
a storage circuit, configured to store a program code;
a processor, coupled to the storage circuit, and configured to access the program code to execute:
reading a first pattern with a defect via a pattern reader, and determining whether the pattern reader reads successfully;
if a reading is successful, performing a pattern reconstruction operation based on pattern information of the read first pattern to obtain a second pattern; and
training a pattern enhancing model based on the first pattern and the second pattern as a training data set.

8. The electronic device according to claim 7, wherein if the reading is successful, a proportion of the defect of the first pattern in the first pattern is less than a threshold.

9. The electronic device according to claim 7, wherein the first pattern comprises a barcode or a QR code.

10. The electronic device according to claim 7, wherein the processor further executes:
if the reading fails, feeding the first pattern into the pattern enhancing model to output an enhanced first pattern; and
reading the enhanced first pattern via the pattern reader.

11. The electronic device according to claim 10, wherein the processor further executes:
if the enhanced first pattern is successfully read, training the pattern enhancing model based on the first pattern and the enhanced first pattern as another training data set.

12. The electronic device according to claim 7, wherein the pattern enhancing model comprises an autoencoder.
